(19) United States
(12) Patent Application Publication
(10) Pub. No.: US 2013/0185120 A1
(43) Pub. Date: Jul. 18, 2013

(54) METHOD AND A SYSTEM FOR ENERGY BENCHMARKING FOR GAP ANALYSIS FOR A PLANT IN A PAPER INDUSTRY

(71) Applicant: ABB Research Ltd, Zurich (CH)

(72) Inventors: Naveen BHUTANI, New Delhi (IN); Tarun Prakash Mathur, Bangalore (IN); Karl-Fredrik Lindberg, Vasteras (SE); Kevin Starr, Lancaster, OH (US); Robert Horton, Alpharetta, GA (US)

(73) Assignee: ABB Research Ltd, Zurich (CH)

(21) Appl. No.: 13/789,041

(22) Filed: Mar. 7, 2013

Related U.S. Application Data
(63) Continuation of application No. PCT/IB2011/002299, filed on Sep. 30, 2011.

(30) Foreign Application Priority Data
Oct. 1, 2010 (IN) 2554/CHE/2010

(51) Int. Cl. G06Q 10/06

(52) U.S. Cl. CPC G06Q 10/06393
USPC 705/7.37

(57) ABSTRACT

Methods and systems for energy benchmarking for gap analysis are disclosed, for example, for a plant in a paper industry having at least one equipment. The method can include a) monitoring the performance parameter of one or more equipments of the plant and/or of one or more other plants and/or of the plant or other plants, the performance parameter being evaluated from design data or plant model or historical operating data or current operating data; b) comparing at least one performance parameter against at least one other performance parameter of the at least one equipment of the one plant or other plant, or of the one plant or at least one other plant or a combination thereof; c) selecting one of the performance parameters from the at least one or other performance parameters being compared; d) setting the value of the selected performance parameter as a benchmark; and e) controlling the plant based on the benchmark.

### RELATED APPLICATION

This application claims priority as a continuation application under 35 U.S.C. §120 to PCT/IP2011/002299, which was filed as an International Application on Sep. 30, 2011 designating the U.S., and which claims priority to Indian Application 2554/CHE/2010 filed in India on Oct. 1, 2010. The entire contents of these applications are hereby incorporated by reference in their entireties.

### FIELD

A method and a system are disclosed for energy benchmarking, such as energy benchmarking for gap analysis of a plant in a paper industry.

### BACKGROUND

Paper industry plants have a paper machine which is used for the making of paper, such as from wood pulp. A paper machine can include a dryer section with other sections such as a wet end section, a wet press section and a calendar section. The dryer section dries the pulp through a series of rollers that are heated by steam, thereby removing the moisture. The steam energy can be important in the paper making process. But, this steam energy can be wasted or used ineffectively due to inefficient operation or inefficient usage of steam energy in and by the equipment in the plant.

Benchmarking can be used for setting a target for energy efficiency, to perform plant energy management, and the losses relating to steam energy can be detected. Currently, benchmarking is made based on historical operating data, current operating data and best practices for the plant. The benchmarking made through this approach, can correspond to and evaluate the potential for operation improvement of the plant.

In current practice, the benchmarking for improvement relating to operational aspects has been addressed and there is no focus on benchmarking for improvement through maintenance in the plant. This may be because of very limited or no use of design performance in the benchmarking, and the decision on maintenance being made based on experience, and/or when the need arises. Though benchmarking for operational improvement can elevate the performance of the plant undoubtedly through corresponding action, the inefficient performance of the plant/equipment is not completely addressed. The reason for this is that due consideration has not been extended to plant design for benchmarking, and plant design should be considered while performing benchmarking.

Hence it would be desirable in energy benchmarking for a gap analysis that includes potential for improvement through maintenance. An integrated approach is disclosed that includes potential for improvement through improved operation and maintenance for energy benchmarking for gap analysis thereof.

### SUMMARY

A method is disclosed for energy benchmarking for a plant having at least one equipment, the plant being one plant either alone or being one plant coexisting with one or more other plants in a plurality of paper industry plants, the method comprising: monitoring at least one performance parameter of at least one equipment of the one plant and/or one or more of other plants, the performance parameter being evaluated from design data or plant model or historical operating data or current operating data; comparing the at least one performance parameter against at least one other performance parameter of the at least one equipment of the one plant or the other plant, or of the one plant or the least one other plant, or a combination thereof; selecting one performance parameter from the at least one or from the other performance parameters being compared; setting a value of the selected performance parameter as a benchmark; and controlling the plant based on the benchmark.

A system is also disclosed for energy benchmarking a plant having at least one equipment, the plant being one plant either alone or being one plant coexisting with one or more other plants in a plurality of paper industry plants, the system comprising: means for obtaining design data of the one plant or one or more other plants; one or more data processors for processing historical operating data, or current operating data, or both of the one plant or one or more other plants; one or more climate filters for segregating the historical operating data or the current operating data or both, accordingly into one or more sets of historical operating data and current operating data based on climatic conditions; a first comparator component for comparing one performance parameter evaluated from design data with another performance parameter evaluated from historical operating data; a second comparator component for comparing one performance parameter evaluated from historical operating data with another performance parameter evaluated from current operating data; and an estimation module for performing estimation for improvement through maintenance or operation or both of the at least one equipment of the one plant or one or more other plants, and/or of the one plant or one or more of the other plants, or a combination thereof.

### BRIEF DESCRIPTION OF THE DRAWING

Exemplary embodiments will be described with reference to the accompanying drawing in which:

FIG. 1 is a schematic drawing depicting the energy benchmarking in accordance with an exemplary method and functional plant system diagram as disclosed herein.

### DETAILED DESCRIPTION

A method is disclosed for energy benchmarking which can include an integrated approach that includes potential for improvement through operational change as well as maintenance.

A method as disclosed herein for energy benchmarking can be employed for a plant associated with different equipment/design, climate, capacity of production, age, products and so forth.

A system as disclosed herein is capable of performing the disclosed method for benchmarking.

In an exemplary method for energy benchmarking for gap analysis for a plant in a paper industry having one or more other plants along with the plant, the plant has at least one equipment. The method can include: a) monitoring at least one performance parameter of at least one equipment of the plant and/or one or more of other plants. The performance parameter can be evaluated from design data or a plant model or historical operating data or current operating data; and b) comparing the at least one performance parameter with at least one other performance parameter. The other performance parameter can be from the at least one equipment of the plant or other plant, or of the one plant or at least one other plant or a combination thereof. The method can also include c) selecting one of the performance parameter from the at least one or other performance parameters being compared; d) setting the value of the selected performance parameter as a benchmark; and e) controlling the plant based on the benchmark.

A system is also disclosed for energy benchmarking a plant as referenced herein, in accordance with the disclosed method. The system can include: a) means to obtain design data (e.g., any data input device); b) one or more data processors for processing historical operating data or current operating data or both; c) one or more climate filters for segregating the historical operating data or the current operating data or both accordingly into one or more sets of historical operating data and current operating data based on climatic conditions; d) a first comparator component for comparing one performance parameter evaluated from design data with another performance parameter evaluated from historical operating data; e) a second comparator component for comparing one performance parameter evaluated from historical operating data with another performance parameter evaluated from current operating data; and f) an estimation module for performing estimation for improvement through maintenance or operation or both.

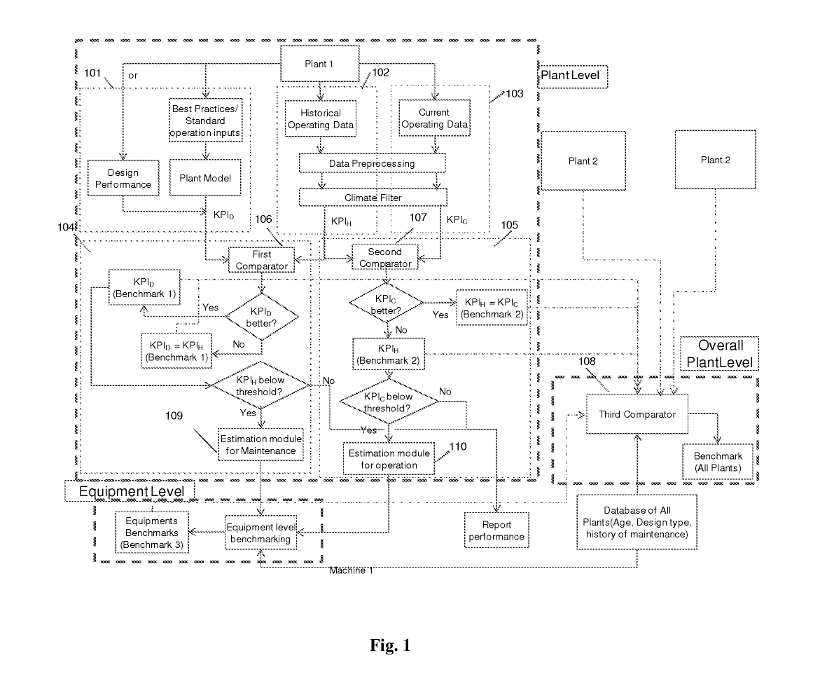

Energy benchmarking is disclosed that can, for example, apply to a plant in a paper industry for gap analysis. An exemplary embodiment is disclosed with reference to the modular, functional system of, for example, specially programmed processors of hardware and/or software as shown in FIG. 1. In a paper industry, a plant has at least one equipment, and there can be one or more such plants. The benchmarking, referred hereinafter in the description, gives due consideration for the best key performance index (KPI) as the performance parameter. However, the performance parameter is not limited thereto with respect to the KPIs. The KPIs relate to the performance of the equipment and/or the plant, and can be deemed to be a measure for analysis. The KPIs for the purpose of an exemplary embodiment include one or more KPIs relating to design of the equipment and/or plant, historical operating data, and current operating data and are termed as KPI_{D}, KPI_{H} and KPI_{C} respectively.

For the purpose of simplicity, an exemplary embodiment is described referring to modules. Reference to such modules is not limiting or restricting in nature, and is merely meant for better understanding of exemplary embodiments disclosed herein.

The first module refers to determining the KPI_{D}. The KPI_{D} is determined from the design performance and/or from the plant model. The plant model herein employs inputs from standards or best practice of the plant. In the case of employing the plant model, the plant model is tuned to match the design performance.

The second module refers to determining the KPI_{H}. The historical operating data is obtained over, or for, a period of time. The historical operating data can be pre-processed by, e.g., a specially programmed data pre-processor configured to remove any spurious data. The pre-processed historical operating data can be segregated into multiple data sets by a climate filter based on similar climatic conditions. Historical performance index can be estimated for each of such data set. A selected (e.g., best) historical performance index is selected from the estimated historical performance indices and is termed herein to be the KPI_{H}.

The third module relates to determining the KPI_{C}. The current operating data of the plant is obtained and preprocessed by, e.g., a specially programmed data pre-processor configured to remove any spurious data. The pre-processed current operating data is segregated into multiple data sets by a climate filter in a similar manner as referred to hereinabove based on climatic conditions. Current performance index is estimated and KPI_{C} is determined thereafter.

The KPIs with regard to design, historical operating data and current operating data (e.g., KPI_{D}, KPI_{H} and KPI_{C}, respectively) are determined in the manner described hereinabove and are compared accordingly in fourth and fifth modules.

In the fourth module, the first comparator component compares KPI_{D} and KPI_{H}. On such comparison, if KPI_{D} is better than KPI_{H}, then benchmark 1 is set to KPI_{D}, else performance at equipment level is evaluated. If KPI_{H} is better than KPI_{D}, then the benchmark is set to KPI_{D} with the value of KPI_{H}. Upon KPI_{D} being set as benchmark 1, the KPI_{H} is further checked against its threshold. If the KPI_{H} is below the threshold value, estimation of potential for improvement through maintenance is performed by the estimation module. After this, the performance at an equipment level is evaluated for effecting equipment level benchmarking pertaining to the plant. However, if the KPI_{H} is not below the threshold, the same is reported with relevance to the performance of the plant.

Similarly, in the fifth module, the second comparator component compares the KPI_{H} and KPI_{C}. If KPI_{C} is better, the KPI_{H} is updated with the KPI_{C} and is set as benchmark 2. On comparison, if KPI_{H} is better, then KPI_{H} is set as benchmark 2 and further, KPI_{C} is checked against its threshold value. If KPI_{C} is above threshold, the same is reported with relevance to the performance of the plant. On the other hand, if KPI_{C} is below threshold value, estimation of potential for improvement through operation is performed by the estimation module and equipment level benchmarking is done thereafter. In the event where both KPI_{H} and KPI_{C} are below threshold value, then estimation of potential for improvement in maintenance is performed by the estimation module. Benchmarks 1 and 2 referred in the fourth and fifth modules respectfully, relate to the benchmarking made at the mill level.

The data being used and estimated or calculated therein during the benchmarking are made available in a database and updated as and when appropriate and applicable. Such data that are available in the database include one or more of the data relating to, for example, age, design type, history of maintenance, etc of the one or more equipment and/or plant mill or a combination thereof.

Table 1 hereinbelow provides examples of KPIs that can be defined for an exemplary plant. The equations for potential steam savings through maintenance and operation are also stated.

TABLE 1

| | | | | Steam | Steam |
|---|---|---|---|---|---|
| | | | | Savings by | Savings |
| | | | | maintenance, | by operation, |
| KPI | KPI_{D} | KPI_{H} | KPI_{C} | tons/hr | tons/hr |
| Specific Steam | SS_{D} | SS_{H} | SS_{C} | P*(SS_{H} − | P*(SS_{C} − |
| usage(SS), tons | | | | SS_{D}) | SS_{H}) |
| steam/ton dry paper | | | | | |
| % Condensate | CR_{D} | CR_{H} | CR_{C} | F_{S}*(CR_{D} − | F_{S}*(CR_{H} − |
| Return (CR) | | | | CR_{H})*E_{C}/E_{S} | CR_{C})*E_{C}/E_{S} |

Few mill level key peformance indices for plants where:
SS is specific steam usage, ton steam/ton dry paper;
SS_{D}, SS_{H} and SS_{C} are specific steam usages relating to design performance, historical operating data and current operating data respectively, tons steam/ton dry paper;
CR is condensate return, %;
CR_{D}, CR_{H} and CR_{C} are condensate returns relating to design performance, historical operating data and current operating data, respectively, %;
KPI is a key performance index;
KPI_{D}, KPI_{H} and KPI_{C} are key performance indices relating to design performance, historical operating data and current operating data respectively;
P is the production rate of paper, tons of dry paper/hr;
F_{S} is the flow rate of fresh steam to plant, tons/hr;
E_{C} is the enthalpy of return condensate, kJ/ton of condensate; and
E_{S} is the energy of fresh steam in kJ/ton of steam.

From the context of the aforestated description, equipment level benchmarking is performed, as explained hereinafter in the description. The benchmarking and gap analysis described herein for the plant level are part of the benchmarking at an equipment level or simply the equipment level benchmarking. After the plant level benchmarking, the equipment level benchmarking can include steps which follow a similar approach as that of benchmarking at plant level, but involves estimating key performance indices for design, historical operating data and current operating data pertaining to equipment. Hence, the benchmarks 3 and 4 for design and historical operating data respectively, are set for all equipment in the plant. The estimation for potential for improvement through maintenance and/or operation is made accordingly when KPI_{H} and/or KPI_{C} go below a threshold value. The efficiency/characteristics performance curves of equipments can be used to define KPI_{D} as a function of operating capacity. This information can be used to estimate performance gap due to operation below or away from design capacity.

For example, the entrainment ratio (ER) which is defined as a ratio of flash steam flow to motive steam flow to the thermo-compressor is a direct indicator of its performance. A higher value of this ratio (e.g., ER) indicates higher recycling of flash steam to paper dryers and its best utilization. This index will affect the energy intensity of a thermo-compressor and can be used to evaluate potential energy savings possible in a thermo-compressor. The KPIs for design, historical operating data and current operating data (e.g., KPI_{D}, KPI_{H} and KPI_{C} respectively), and specific energy for flash steam and motive steam are given in Table 2, hereinbelow for entrainment ratios with respect to design, historical operating data and current operating data (e.g., ER_{D}, ER_{H} and ER_{C}). The ER for flash steam energy and motive steam energy are represented as E_{FS} and E_{MS} respectively.

TABLE 2
Few equipment level key performance indices for plants

| | | | | Flash Steam | |
|---|---|---|---|---|---|
| | | | | Energy, | Motive Steam |
| KPI | KPI_{D} | KPI_{H} | KPI_{C} | kJ/ton | Energy, kJ/ton |
| Entrainment Ratio | ER_{D} | ER_{H} | ER_{C} | E_{FS} | E_{MS} |
| (ER), tons/ton | | | | | |

Table 3 provide equations for calculation of energy intensities (design, historical operating data and current operating data; e.g., EI_{D}, EI_{H} and El_{C} respectively), kJ/ton of discharge steam, as a function of the above KPI values (e.g., ER) and the potential energy savings by improvement through maintenance and operation. It is to be noted that energy intensity decreases with the increase in ER.

TABLE 3
Exemplary equations for calculation of steam energy savings in plants.

| | | | | Energy | |
|---|---|---|---|---|---|
| | | | | Savings | Energy |
| | | | | by | Savings |
| | | | | mainte- | by |
| | EI_{D}, | EI_{H} | EI_{C} | nance, | operation, |
| | kJ/ton | kJ/ton | kJ/ton | kJ/ton | kJ/ton |
| KPI | steam | steam | steam | steam | steam |
| Entrainment | (E_{MS} + | (E_{MS} + | (E_{MS} + | EI_{H} − EI_{D} | EI_{C} − EI_{H} |
| Ratio (ER), | ER_{D} × | ER_{H} × | ER_{C} × | | |
| tons/ton | E_{FS})/ | E_{FS})/ | E_{FS})/ | | |
| | (1 + ER_{D}) | (1 + ER_{H}) | (1 + ER_{C}) | | |

The benchmarks set in plant level and equipment level as inferred from the hereinabove description for one plant can be stored in a database (e.g., memory device) and the same can be meaningfully compared by a third comparator component with such similar benchmarks as that being set for one or more other plants, thereby setting overall benchmarks.

The plants in the paper industry can differ in their configuration, design/technology, scale of operation and age. Therefore, the benchmark from historical operation data alone may not be sufficient for gap analysis between two plants that are very much variant. Accordingly, during such instances, the overall benchmarking can be set based on one or more of the following:
a) Benchmarks set at individual plant level are sufficient for gap analysis as target improvement is being set based on their design and historical operating data itself.
b) Benchmark defined for design performance of one plant can be compared with design performance of the other plant. A better configuration can then be proposed as a benchmark. A new configuration may be adapted or the improvement in the existing configuration can be made in the plant based on its production needs and available resource. For example, a plant can move from a configuration without a hood to a configuration with a hood.
c) Benchmark defined for design performance of an equipment in one plant can be compared with that of a design benchmark for equipment with similar functionality in another plant no matter even if the design type is different.
d) Benchmarks for operation performance can be normalized with respect to their design before comparison with other plants. The design performance is given as a function of operating capacity.

In the above integrated multi-level benchmarking approach, the benchmarks are set at individual plant level, equipment level and multiple plant level in reference to their design and historical performance.

Exemplary embodiments disclosed herein can differentiate between the improvement through operation and maintenance and the performance parameter evaluated, and the benchmarks set for an equipment and/or plant for design, historical and current performance correspondingly in relation with historical and current operation data are sufficient to quantitatively estimate the potential for improvement through maintenance and operation. The gap analysis can therefore be done meaningfully in comparison to the benchmark based on historical operating data as well as in reference to the design. Direct comparisons of operating performance based on operating data of multiple plants are not always relevant for benchmarking due to the difference that can persist because of the climatic conditions, design, configuration etc. But, this can be addressed by exemplary embodiments disclosed herein wherein, benchmarks set based on design performance in one plant can be quantitatively compared with the design benchmark of other plants, though the equipment type, etc differ.

Further, the plant can be controlled based on the set benchmarks and the estimation done for improvement through maintenance and/or operation.

Exemplary embodiments of the present disclosure have been described with respect to the operative features the structural components perform. The exemplary embodiments of the present disclosure can also be implemented by at least one processor (e.g., general purpose or application specific) of a computer processing device (including hardware, software or a combination of both) which is configured to execute a computer program tangibly recorded on a non-transitory computer-readable recording medium, such as a hard disk drive, flash memory, optical memory or any other type of non-volatile memory. Upon executing the program, the at least one processor is configured to perform the operative functions of the above-described exemplary embodiments.

The foregoing specification refers to exemplary embodiments and is not exhaustive in nature. Certain aspects of the invention that have not been explicitly elaborated herein can be well understood by a person skilled in the art. Variations and modifications of the aspects with any relevance to the invention are construed to be well within the scope of the invention.

As such, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

We claim:

1. A method for energy benchmarking for a plant having at least one equipment, the plant being one plant either alone or being one plant coexisting with one or more other plants in a plurality of paper industry plants, the method comprising:
monitoring at least one performance parameter of at least one equipment of the one plant and/or one or more of other plants, the performance parameter being evaluated from design data or plant model or historical operating data or current operating data;
comparing the at least one performance parameter against at least one other performance parameter of the at least one equipment of the one plant or the other plant, or of the one plant or the least one other plant, or a combination thereof;
selecting one performance parameter from the at least one or from the other performance parameters being compared;
setting a value of the selected performance parameter as a benchmark; and
controlling the plant based on the benchmark.

2. The method as claimed in claim 1, wherein the said performance parameter is a key performance index (KPI) based on design performance curves and/or plant model, a KPI based on historical operating data and/or a KPI based on current operating data.

3. The method as claimed in claim 1, wherein the comparing comprises:
comparing the one performance parameter with the at least one another performance parameter that involves evaluated design data or plant model or historical operating data or current operating data.

4. The method as claimed in claim 1, wherein the comparing comprises:
performing the comparison of the one performance parameter evaluated from design data with the other performance parameter which is evaluated from historical operating data, by a first comparator component.

5. The method as claimed in claim 1, wherein the comparing comprises:
performing the comparison of the one performance parameter evaluated from historical operating data with the other performance parameter which is evaluated from current operating data by a second comparator component.

6. The method as claimed in claim 4, wherein the setting of a benchmark comprises:
performing estimation for improvement through maintenance when the one performance parameter evaluated from historical operating data is below a threshold value.

7. The method as claimed in claim 5, wherein the setting of a benchmark comprises:
performing estimation for improvement through operation when the other performance parameter evaluated from current operating data is below the one performance parameter evaluated from historical operating data, and/or performing estimation for improvement through maintenance when both the one and other performance parameters evaluated from historical operating data and current operating data, respectively are below a threshold value.

8. A system for energy benchmarking a plant having at least one equipment, the plant being one plant either alone or being one plant coexisting with one or more other plants in a plurality of paper industry plants, the system comprising:
means for obtaining design data of the one plant or one or more other plants;
one or more data processors for processing historical operating data, or current operating data, or both of the one plant or one or more other plants;
one or more climate filters for segregating the historical operating data or the current operating data or both, accordingly into one or more sets of historical operating data and current operating data based on climatic conditions;
a first comparator component for comparing one performance parameter evaluated from design data with another performance parameter evaluated from historical operating data;
a second comparator component for comparing one performance parameter evaluated from historical operating data with another performance parameter evaluated from current operating data; and
an estimation module for performing estimation for improvement through maintenance or operation or both of the at least one equipment of the one plant or one or more other plants, and/or of the one plant or one or more of the other plants or a combination thereof.

9. The system as claimed in claim 8, wherein the means for obtaining design data comprises:
one or more plant models that provide design data corresponding to one or more of the one or other plants.

10. The system as claimed in claim 8, comprising:
a third comparator component for comparing the one performance parameter of the one plant with the other plant.

11. The method as claimed in claim 2, wherein the comparing comprises:
comparing the one performance parameter with the at least one another performance parameter that involves evaluated design data or plant model or historical operating data or current operating data.

12. The method as claimed in claim 2, wherein the comparing comprises:
performing the comparison of the one performance parameter evaluated from design data with the other performance parameter which is evaluated from historical operating data, by a first comparator component.

13. The method as claimed in claim 11, wherein the comparing comprises:
performing the comparison of the one performance parameter evaluated from design data with the other performance parameter which is evaluated from historical operating data, by a first comparator component.

14. The method as claimed in claim 13, wherein the comparing comprises:
performing the comparison of the one performance parameter evaluated from historical operating data with the other performance parameter which is evaluated from current operating data by a second comparator component.

15. The method as claimed in claim 14, wherein the setting of a benchmark comprises:
performing estimation for improvement through maintenance when the one performance parameter evaluated from historical operating data is below a threshold value.

16. The method as claimed in claim 15, wherein the setting of a benchmark comprises:
performing estimation for improvement through operation when the other performance parameter evaluated from current operating data is below the one performance parameter evaluated from historical operating data, and/or performing estimation for improvement through maintenance when both the one and other performance parameters evaluated from historical operating data and current operating data, respectively are below a threshold value.

17. The system as claimed in claim 9, comprising:
a third comparator component for comparing the one performance parameter of the one plant with the other plant.
